(19) United States
(12) Patent Application Publication
(10) Pub. No.: US 2004/0148398 A1
(43) Pub. Date: Jul. 29, 2004

(54) Method of automatically registering an IP address and domain name in IP protocol version 6

(75) Inventor: Soo-Hong Park, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/679,445

(22) Filed: Oct. 7, 2003

(30) Foreign Application Priority Data
Jan. 15, 2003 (KR) 2003-2722

(51) Int. Cl. G06F 15/16

(52) U.S. Cl. 709/227

(57) ABSTRACT

There is provided a method for automatically registering an IP address and domain name of a host in a network using the IP Version 6 (IPv6) protocol. The IP address and domain name automatic registration method includes: multicasting an NS message, which includes the IP address and domain name of the host, performing a Duplicate Address Detection (DAD) process, and if no other host exists on the same network and uses the IP address or domain name of the host, automatically registering the IP address or domain name in a DNS server or in the respective storage areas of the plurality of other hosts. Therefore, the IPv6 address and domain name of each host can be automatically stored and managed without duplication.

### BACKGROUND OF THE INVENTION

This application claims priority from Korean Patent Application No. 2003-2722, filed on Jan. 15, 2003, in the Korean Intellectual Property Office, the disclosure of which is incorporated herein in its entirety by reference.

1. Field of the Invention

The present invention relates to a method of managing an Internet Protocol (IP) address and domain name of a host computer utilizing a Domain Name Service (DNS), and more particularly to a method of automatically registering an IP address and domain name of a host computer on the IPv6 network.

2. Description of the Related Art

Generally, since an IP Version 6 (IPv6) address is a numeric representation of 128 bits, direct usage of the IPv6 address is difficult. For this reason, a DNS function is used, which performs translations between IP addresses and corresponding domain names.

FIG. 1 is a view showing a conventional Domain Name Service (DNS) environment, and FIG. 2 is a flow chart illustrating a general DNS process performed in the conventional DNS environment of FIG. 1.

Referring to FIG. 1, when a first host (IPv6 Host0) 13, connected to a DNS server 11, tries to access a second host (IPv6 Host1) 15, the first host 13 requests the IP address of the second host 15 from the DNS server 11. The process for performing such a DNS function is described as follows.

Referring to FIG. 2, when the first host 13 desires to access another host, such as the second host 15, it transmits a DNS query message to the DNS server 11 (step 101). The DNS query message includes the domain name (for example, Host1.example.com) of the host that the first host 13 wishes to access, in this case, the second host 15. The DNS server 11 checks the DNS query message transmitted from the first host 13 (step 102) and then transmits to the first host 13 the IP address (for example, fe80::bbbb) corresponding to the domain name of the second host 15 (step 103). After receiving the IP address of the second host 15 from the DNS server 11, the first host 13 accesses the second host 15 using the IP address (step 104).

To perform such a DNS function, it is necessary to create a DNS zone file for managing the IPv6 address and domain name of each host.

FIG. 3 is a view showing an exemplary construction of the DNS zone file. Referring to FIG. 3, the IPv6 address and domain name of each host are registered and managed by the DNS zone file, and the IP addresses and domain names of respective hosts are set individually and manually by a manager.

However, in a network environment where hosts are often changed and domain names often vary, problems exist such as the need for continuous update of the DNS zone file and the possibility of duplicating IPv6 addresses and domain names of host computers due to a user's carelessness.

### SUMMARY OF THE INVENTION

The present invention provides a method of automatically registering an IPv6 address and IPv6 domain name of a host computer on a Domain Name Service (DNS) server (or, other hosts).

The present invention also provides a computer readable medium having embodied thereon a computer program for the method.

According to an aspect of the present invention, there is provided a first method of automatically registering an IP address and domain name, the method comprising: (a) generating in a host, a Duplicate Address Detection (DAD) request message including an IP address and domain name of the host; (b) receiving the DAD request message through one among a Domain Name Service (DNS) server and a plurality of other hosts connected to each other over a network of the host, and determining whether another host that uses at least one among the IP address and the domain name included in the DAD request message exists on the network of the host; and (c) if another host is not determined, storing the IP address and the domain name in one among a DNS zone file of the DNS server and storage areas of the other hosts.

According to another aspect of the present invention, there is provided a second method of automatically registering an IP address and domain name, the method comprising: (a) transmitting a DAD request message, including an IP address and domain name of a host, from the host to a DNS server; (b) determining whether another host that uses at least one among the IP address and the domain name included in the DAD request message exists on the network of the host; and (c) if another host is not determined, storing the IP address and the domain name in a DNS zone file of the DNS server.

According to still another aspect of the present invention, there is provided a (check original) third method of automatically registering an IP address and domain name, the method comprising: (a) transmitting a DAD request message including an IP address and domain name of a host, from the host to a plurality of other hosts connected to each other over a network; (b) determining whether another host that uses at least one of the IP address and the domain name included in the DAD request message exists on the network of the host and; (c) if another host is not determined, storing the IP address and the domain name in respective storage areas of the other hosts.

### BRIEF DESCRIPTION OF THE DRAWINGS

The above and other features and advantages of the present invention will become more apparent by describing in detail exemplary embodiments thereof with reference to the attached drawings in which:

FIG. 1 is a view showing a conventional Domain Name Service (DNS) environment;

FIG. 2 is a flow chart illustrating a general DNS process performed in the conventional DNS environment of FIG. 1;

FIG. 3 is a view showing an exemplary construction of a DNS zone file;

FIG. 4 is a view for describing an expansion type Neighbor Solicitation (NS) message and a method for performing automatic registration of the IP address and domain name of a host using the same, according to a preferred embodiment of the present invention;

FIG. 5 is a flow chart illustrating the method of performing automatic registration of the IP address and domain name of the host, according to the preferred embodiment of the present invention;

FIG. 6 is a view showing an exemplary structure of a Neighbor Advertisement (NA) message generated when the IP address of the host is duplicated, according to the preferred embodiment of the present invention; and

FIG. 7 is a view showing an exemplary structure of an expansion type NA message generated when the domain name of the host is duplicated, according to the preferred embodiment of the present invention.

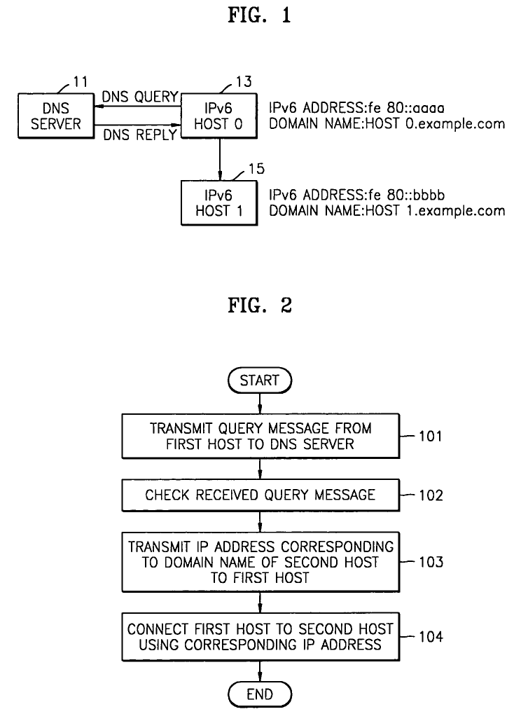

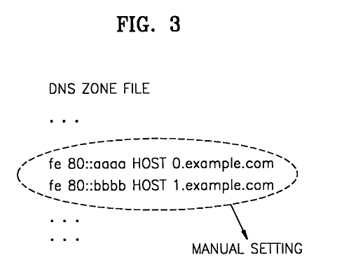

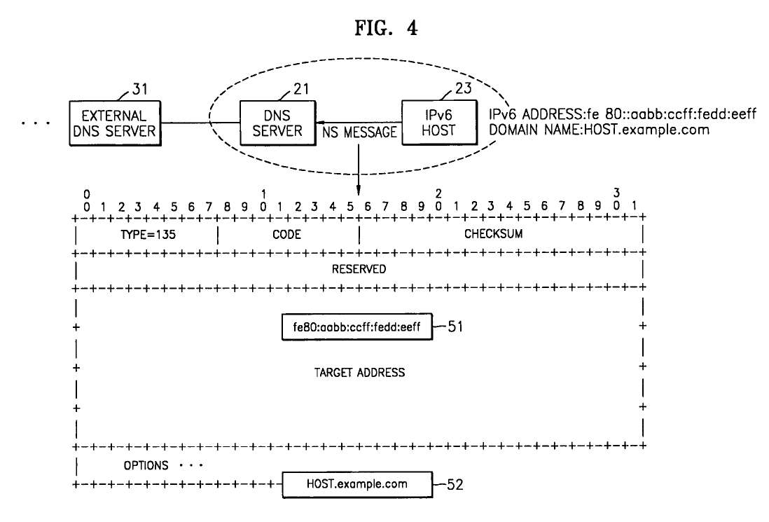

### DETAILED DESCRIPTION OF THE INVENTION

Hereinafter, embodiments of the present invention will be described in detail with reference to the appended drawings.

FIG. 4 is a view for describing an expansion type Neighbor Solicitation (NS) message, and a method of automatically registering an IP address and domain name of a host using the expansion type NS message, according to a preferred embodiment of the present invention.

Referring to FIG. 4, according to the IP address and domain name automatic registration method of the present invention, an IPv6 address and domain name of a host 23 are automatically registered in a Domain Name Service (DNS) zone file of a DNS server 21 through the Duplicate Address Detection (DAD) process of the IPv6 protocol. Here, the DNS server 21 is a server capable of supporting the IPv6 protocol and the host 23 is a host capable of performing an auto-configuration function.

To perform the automatic registration of the IP address and domain name of the host, the host 23 transmits an NS message to the DNS server 21 when the DNS server 21 is turned on. The NS message is a type of DAD request signal for enabling DAD. Also, other signals may act as substitutes for the NS message, according to implementation schemes of the present invention.

As shown in FIG. 4, the expansion type NS message stores the host's own IPv6 address (for example, fe80::aabb::ccff::fedd::eeff) 51 in the target address field thereof, and stores the host' own domain name (for example, Host.example.com) 52 in the option field thereof. Here, the source address (SRC) is set as blank, and the destination address (DST) is set as the value ff02::1:fedd:eeff, which is a solicited node multicasting address corresponding to the target address fe80::aabb::ccff::fedd::eeff. The IPv6 address 51 of the host 23 stored in the target address field of the NS message is a link-local address, which is used within a sub-network without connection to any external network, or converted into a site-local address or global address for use in a global network environment, etc.

When the DNS server 21 receives the NS message from the host 23, the DNS server 21 performs the DAD process and attempts to detect another host that uses the IP address or domain name. If no other host exists on the same network and uses the IP address or domain name of the host 23, the DNS server 21 stores and manages the IP address (that is, IPv6 address) and domain name of the corresponding host 23 in the DNS zone file thereof.

Meanwhile, the DNS server 21 is connected to a plurality of external DNS servers 31, included in local networks different from the local network of server 23 and shares the information obtained through the DAD process with the other DNS server 31. Accordingly, although a manager does not individually store the respective IP addresses and domain names of the respective hosts, the IP addresses and domain names of the respective hosts are automatically registered and managed without being duplicated.

Therefore, according to the IP address and domain name automatic registration method of the present invention, an IP address and domain name of a host can be automatically registered and managed, even though a DNS server is not provided. For example, in a network environment without a DNS server 21, an NS message including the IP address and domain name of a corresponding host is solicited-node-multicasted to other hosts on the network during the DAD process, and the IP address and domain name of the corresponding host are automatically registered in predetermined storage areas of the other hosts. That is, even without a DNS server, interconnection of a corresponding host and other hosts can be achieved using only the IP address and domain name.

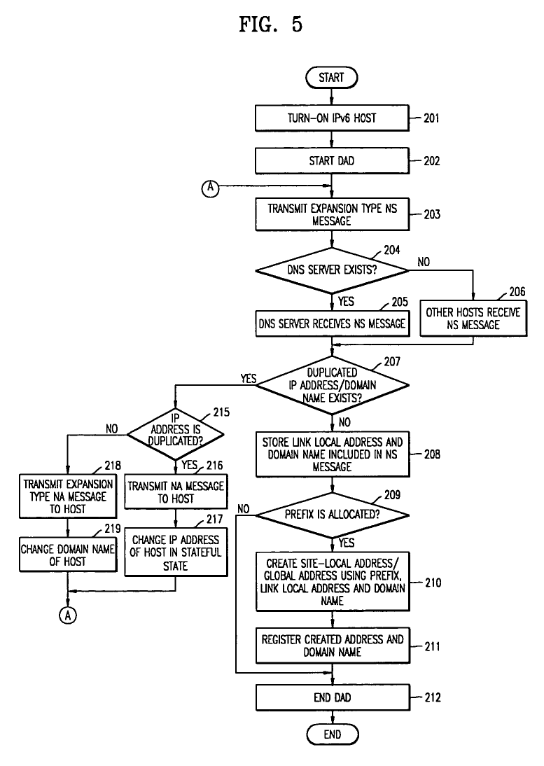

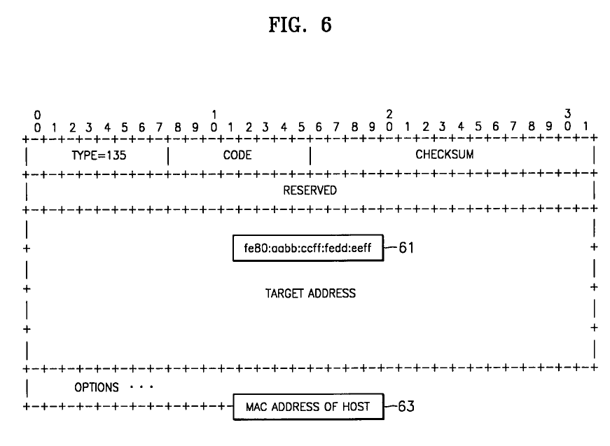

FIG. 5 is a flow chart illustrating the method of automatically registering the IP address and domain name of the host, according to the preferred embodiment of the present invention, wherein the method is applied to both a network environment with a DNS server and a network environment without a DNS server.

Referring to FIG. 5, an IPv6 host is turned on (step 201) and the DAD process begins (step 202). The DAD process is enabled to determine whether the IP address (that is, IPv6 address) of the host is duplicated.

Then, the host multicasts and transmits an expansion type NS message, which stores the host' own IPv6 address in the target address field thereof and the host's own domain name in the option field thereof, as shown in FIG. 4 (step 203).

Successively, it is determined whether a DNS server exists (step 204). If a DNS server exists, the NS message is transferred from the host to the DNS server (step 205). If the DNS server does not exist, the NS message is transferred to a plurality of other hosts connected on the network (step 206). As will be described below, if the DNS server exists, the DAD process is performed by the DNS server, and the IP address and domain name of the host are registered on the DNS server. If the DNS server does not exist, the DAD process is performed by all the other hosts connected on the network, and the IP address and domain name of the corresponding host are stored in the predetermined storage areas of the other hosts.

Then, the DNS server (or, the plurality of other hosts) that received the NS message determines whether another host exists on the network and uses the IP address or domain name stored in the NS message (step 207).

If no other host exists on the same network and uses the IP address or domain name, the DNS server (or the plurality of other hosts) stores the link local address (that is, target address) and domain name of the host, included in the NS message, in the DNS area file thereof (or, the storage areas of the other hosts) (step 208). Then, it is determined whether a prefix is allocated, using prefix information transmitted from a router or a device functioning as the same (step 209).

If the prefix is allocated, a site-local address and global address are generated using the allocated prefix, and the link local address and domain name of the host included in the NS message (step 210). Successively, the generated site-local address and domain name are registered on the DNS server (or, the other hosts) (step 211). If the link local address and domain name stored at step 208 are already registered in the DNS server (or, the other hosts), the stored link local address and domain name are updated to the generated address and domain name in step 209. On the other hand, if the prefix is not allocated (that is, in an environment to which separate prefix information is not allocated), in step 209, the process proceeds to step 212 and DAD ends without updating.

In step 207, if another host exists on the same network and uses the IP address or domain name of the corresponding host, it is determined whether the IP address of the host is duplicated or the domain name of the host is duplicated (step 215).

If the IP address of the host is duplicated, the DNS server (or, the other hosts) transmits as a DAD response message to the host, a Neighbor Advertisement (NA) message indicating that the IP address of the host is duplicated (step 216). The NA message is an example of a DAD response message informing the corresponding host that the IP address of the host is duplicated. Also, other signals may act as substitutes for the NA message, according to implementation schemes of the present invention.

FIG. 6 is a view showing an exemplary structure of the NA message, which is generated when the IP address of the host is duplicated. Referring to FIG. 6, the target address field stores the IPv6 address 61 of the corresponding host, as in the NS message shown in FIG. 4. The option field of the NA message stores the Media Access Control (MAC) address 63 of the corresponding host. The MAC address is a physical address of the Ethernet card and is written on the Read Only Memory (ROM) of the Ethernet card. The MAC address has a different value for each host.

Returning to FIG. 5, if the NA message shown in FIG. 6 is transmitted to the host when the IP address of the host is duplicated, the host is connected to a Dynamic Host Configuration Protocol for IPv6 (DHCPv6) and a new IP address is allocated to the host (step 217). Then, returning to step 203 (denoted by “A”), the DAD process is repeated from the beginning.

In step 215, if only the domain name of the host is duplicated without the duplication of the IP address, the DNS server (or, the other hosts) transmits as a DAD response message to the host, an expansion type NA message indicating that the domain name of the corresponding host is duplicated (step 218). The expansion type NA message is an example of a DAD response message informing the corresponding host that the domain name of the host is duplicated. Also, other signals may act as substitutes for the expansion type NA message, according to implementation schemes of the present invention.

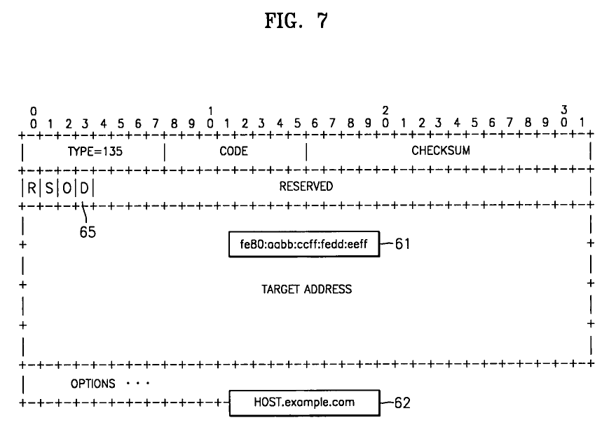

FIG. 7 is a view showing an exemplary structure of the expansion type NA message, which is generated when the domain name of the host is duplicated. If the domain name of the host is duplicated, any NA message having the format shown in FIG. 7 is transmitted to the host, indicating a request to change the domain name of the host. Referring to FIG. 7, the NA message according to the present invention stores the IPv6 address 61 of the host in its target address field and stores the domain name 62 of the host in its option field, like the NS message shown in FIG. 4. In the reserved field, the D flag 65 is set to a predetermined value, which allows the host to change its domain name. The location and value of the flag indicating a request to change the domain name can vary.

Returning to FIG. 5, if the expansion type NA message shown in FIG. 7 is transmitted to the host when the domain name of the host is duplicated, the host changes its own domain name (step 219) and returns to step 203 (denoted by “A”) to repeat the DAD process. In this case, the NS message transmitted in step 203 is unicasted without being multicasted, since a previous check for duplication has already occurred regarding the host's IP address in the NS message. Therefore, it is possible to reduce unnecessary data transmission on the network.

As described above, according to the IP address and domain name automatic registration method of the present invention, an IPv6 address and domain name of each host can be automatically stored and managed in a DNS zone file of a DNS server. This IP address and domain name automatic registration method can also be applied to a network environment without a DNS server. That is, in a network environment without a DNS server, a plurality of other hosts connected to the network perform the DAD process (that is, step 206 of FIG. 5), and register the IP address and domain name of the corresponding host in their storage areas.

Therefore, the IP address and domain name automatic registration method according to the present invention can store and manage the IPv6 address and domain name of each host without duplication, in both a network environment with a DNS server and a network environment without a DNS server. Accordingly, it is possible to construct a Zero Configuration Networking environment, which allows specific computers to access the Internet using only a connection port, and without resetting network information suitable to the corresponding environment, when the computers try to access the Internet in different computing environments.

The present invention may be embodied in a general purpose digital computer by running a program from a computer readable medium, including but not limited to storage media such as magnetic storage media (e.g., ROM's, floppy disks, hard disks, etc.), optically readable media (e.g., CD-ROMs, DVDs, etc.) and carrier waves (e.g., transmissions over the Internet), The present invention may be embodied as a computer readable medium, with a computer readable program code unit embodied therein for causing a number of computer systems connected via a network to affect distributed processing.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of automatically registering an IP address and domain name, the method comprising:
(a) generating in a host, a Duplicate Address Detection (DAD) request message including an IP address and domain name of the host;
(b) receiving the DAD request message through one of a Domain Name Service (DNS) server and a plurality of other hosts connected to each other over a network of the host, and determining whether another host that uses at least one of the IP address and the domain name included in the DAD request message exists on the network of the host; and
(c) if it is determined that said another host does not use said at least one of the IP address and the domain name, storing the IP address and the domain name in one of a DNS zone file of the DNS server and storage areas of the plurality of other hosts.

2. The method of claim 1, wherein the DAD request message comprises:
a target address field which stores the IP address of the host; and
an option field which stores the domain name of the host.

3. The method of claim 2, wherein the IP address of the host is an IP version 6 (IPv6) address.

4. The method of claim 1, further comprising:
(d) determining whether a prefix is allocated;
(e) if the prefix is allocated, creating a new IP address representing one of a site-local address and a global address, using the prefix, the IP address, and the domain name; and
(f) registering the newly created IP address and the domain name in one of the DNS server and at least one of the plurality of other hosts.

5. The method of claim 1, further comprising:
(g) if it is determined that said another host uses said at least one of the IP address and the domain name, determining whether one of the IP address and the domain name is duplicated;
(h) if the IP address is duplicated, transmitting a first DAD response message to the host;
(i) responding to the first DAD response message by updating the IP address of the host and repeating the steps (a) through (c);
(j) if the domain name is duplicated, transmitting a second DAD response message to the host; and
(k) responding to the second DAD response message by changing the domain name of the host and repeating the steps (a) through (c);

6. The method of claim 5, wherein the first DAD response message comprises:
a target address field which stores the IP address of the host; and
an option field which stores a Media Access Control (MAC) address of the host.

7. The method of claim 5, wherein the second DAD response message comprises:
a target address field which stores the IP address of the host;
an option field which stores the domain name of the host; and
a flag having a predetermined value, which is used for indicating a request to change the domain name.

8. A method of automatically registering an IP address and domain name, the method comprising:
(a) transmitting a Duplicate Address Detection (DAD) request message, including an IP address and domain name of a host, from the host to a Domain Name Service (DNS) server;
(b) determining whether another host that uses at least one of the IP address and the domain name included in the DAD request message exists on the network of the host; and
(c) if it is determined that said another host does not use at least one of the IP address and the domain name, storing the IP address and the domain name in a DNS zone file of the DNS server.

9. The method of claim 8, wherein the DAD request message comprises:
a target address field which stores the IP address of the host; and
an option field which stores the domain name of the host.

10. The method of claim 9, wherein the IP address of the host is an IP version 6 (IPv6) address.

11. The method of claim 8, further comprising:
(d) determining whether a prefix is allocated;
(e) if a prefix is allocated, creating a new IP address representing one of a site-local address and a global address, using the prefix, the IP address, and the domain name; and
(f) registering the newly created IP address and the domain name in the DNS server.

12. The method of claim 8, comprising:
(g) if it is determined that said another host uses said at least one of the IP address and the domain name, determining whether one among the IP address and the domain name is duplicated;
(h) if the IP address is duplicated, transmitting a first DAD response message to the host;
(i) responding to the first DAD response message by updating the IP address of the host and repeating the steps (a) through (c);
(j) if the domain name is duplicated, transmitting a second DAD response message to the host; and
(k) responding to the second DAD response message by changing the domain name of the host and repeating the steps (a) through (c);

13. The method of claim 12, wherein the first DAD response message comprises:
a target address field which stores the IP address of the host; and
an option field which stores a Media Access Control (MAC) address of the host.

14. The method of claim 12, wherein the second DAD response message comprises:
a target address field which stores the IP address of the host;
an option field which stores the domain name of the host; and
a flag having a predetermined value, which is used for indicating a request to change the domain name.

15. A method of automatically registering an IP address and domain name, the method comprising:
(a) transmitting a Duplicate Address Detection (DAD) request message including an IP address and domain name of a host, from the host to a plurality of other hosts connected to each other over a network;
(b) determining whether another host that uses at least one of the IP address and the domain name included in the DAD request message exists on the network of the host and;
(c) if it is determined that said another host does not exist in the step (b), storing the IP address and the domain name in respective storage areas of the plurality of other hosts.

16. The method of claim 15, wherein the DAD request message comprises:
a target address field which stores the IP address of the host;
an option field which stores the domain name of the host.

17. The method of claim 16, wherein the IP address of the host is an IP version 6 (IPv6) address.

18. The method of claim 15, further comprising:
(d) determining whether a prefix is allocated;
(e) if a prefix is allocated, creating a new IP address representing one of a site-local address and a global address, using the prefix, the IP address, and the domain name; and
(f) registering the newly created IP address and the domain name in the plurality of other hosts.

19. The method of claim 15, further comprising:
(g) if it is determined that said another host uses at least one of the IP address and the domain name, determining whether one among the IP address and the domain name is duplicated;
(h) if the IP address is duplicated, transmitting a first DAD response message to the host;
(i) responding to the first DAD response message by updating the IP address of the host and repeating the steps (a) through (c);
(j) if the domain name is duplicated, transmitting a second DAD response message to the host; and
(k) responding to the second DAD response message by changing the domain name of the host and repeating step (a) through (c).

20. The method of claim 19, wherein the first DAD response message comprises:
a target address field which stores the IP address of the host;
an option field which stores a MAC address of the host.

21. The method of claim 19, wherein the second DAD response message comprises:
a target address field which stores the IP address of the host;
an option field which stores the domain name of the host; and
a flag having a predetermined value, which is used for indicating a request to change the domain name.

22. A computer readable medium having embodied thereon a computer program for performing the method according to any one of claims 1, 8, and 15.
